(19) United States
(12) Patent Application Publication
(10) Pub. No.: US 2009/0223420 A1
(43) Pub. Date: Sep. 10, 2009

(54) Shipping pallet

(76) Inventors: Tobi W. Ferguson, Lutz, FL (US); Antonio B. Soria, Wesley Chapel, FL (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/074,634

(22) Filed: Mar. 5, 2008

(51) Int. Cl. B65D 19/22; B23P 19/04

(52) U.S. Cl. 108/51.3; 29/700

(57) ABSTRACT

A shipping pallet made from a first cardboard sheet having two sides with pre-set folds to form a box at each side positioned under the sheet. A fastener holds the shape of the box at each side. A pair of second cardboard sheets each having a pre-set fold forming a “L” shape and sized to fit inside one of the boxes such that such that the ends of the “L” shape engage inner corners of the box and the bend in the “L” contacts the inner top surface of the box.

### BACKGROUND

The present invention relates to shipping pallets. More particularly the present invention relates to pallets that are inexpensive to make, easy to store, and strong enough to support conventional loads.

Pallets have been used for many years as supports for a wide variety of goods. Pre-packaged in separate small units and secured atop individual pallets, goods can then be lifted and moved around with the use of fork lift trucks. Traditionally, pallets have been made entirely of wood, but such combinations are not only expensive to construct but also bulky to store and difficult to recycle. There is a need for low cost, easy to store and recyclable pallets. Pallets which can be easily fabricated in a wide range of custom sizes are also highly desirable.

Corrugated paper dates to the mid-19th century and corrugated paper for shipping pallets dates to the early 1970's in Japan. Most are based upon multiplying folded corrugated sheets to approximate the wooden stringers of conventional pallets.

Corrugated pallets have many advantages. Unlike wooden, plastic, or metal pallets, corrugated can be recycled at the recipient's location as paper/card board and does not have to be returned for reuse. Even so called “pallet pools” ship a lot of air.

There exists a need for simple corrugated pallet designs which are strong but do not require expensive multiple-step die cutting and folding steps, do not require excessive adhesive to assemble and which can be assembled at the user's site by minimally skilled laborers.

### SUMMARY

The present invention is a pallet device used for shipping objects like boxes and packages. The pallet device is formed from a first cardboard sheet having a front, a back and two sides, the two sides having pre-set folds such that the sides fold to form a box at each side positioned under the sheet. The boxes are fastened to the underside of the remaining part of the sheet.

A pair of second cardboard sheets each having a pre-set fold are bent into an “L” shape. The “L” shape sheets are sized to fit inside the boxes on the bottom of the first sheet, to provide additional support. Maximum strength is obtained when the ends of the “L” shape sheet engage inner corners of the box and the bend in the “L” contacts an inner surface of the box.

The first sheet and pair of second sheets are preferably formed from two ply cardboard. The boxes are fastened by any suitable fastening means. Staples are preferred.

The pre-set folds in the first sheet and pair of second sheets may be formed by creasing or by cutting a portion of the sheet, such as just through the top surface of the sheets.

To achieve maximum load carrying capability, it is preferred to form a pair of these pallet devices and place them side by side such that each of the pair supports about half the load to be carried. The pair can be fastened together.

### BRIEF DESCRIPTION OF THE DRAWINGS

FIG. 1 is a perspective view of the present invention shown carrying a load.

FIG. 2 is a perspective view of the components of the present invention.

FIG. 3 is a perspective view showing the assembly of the parts of the present invention.

### DETAILED DESCRIPTION

As shown in the figures, a pallet device, 10 generally, is designed to carry a load, such as box 11. It is intended that any products or objects carried by conventional pallets can be used with the present invention. It is intended that the pallet device accommodate the use of fork lifts and other means for lifting, moving and storing pallets having product thereon.

The pallet is formed from a first sheet 13 of cardboard that has a series of pre-set folds 15a, 15b and 15c on the sides of sheet 13 that are folded to form a box 15. Also provided are a pair of second sheets 17 that have a pre-set fold 17a that allows the sheet 17 to be formed into a “L” shape as shown in FIG. 3. The sheets 17 are sized to fit inside boxes 15, specifically such that the ends 17b of sheets 17 engage a corner 15b and 15c of boxes 15 and the pre-set fold 17a engages an inner surface 15d of box 15. This triangular insert thus engages the box to provide maximum strength because the “L” shape inserted in this manner provides for compressive forces on the sheets rather than bending. With the center 17a of the “L” on the top surface, as shown, the box 15 thus has a support in the middle.

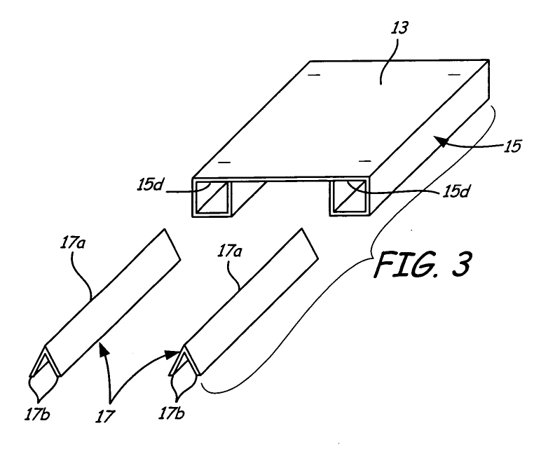

The cardboard of this invention can be any conventional cardboard material, though two ply cardboard is preferred. Pre-set folds 15 a, etc., can then be cut into the surface of the sheet 13 to assist in aligning the formation of boxes 15. Staples 19 are shown in FIG. 2 holding the boxes 15 in position on sheet 13. For additional strength, the cardboard can be corrugated cardboard.

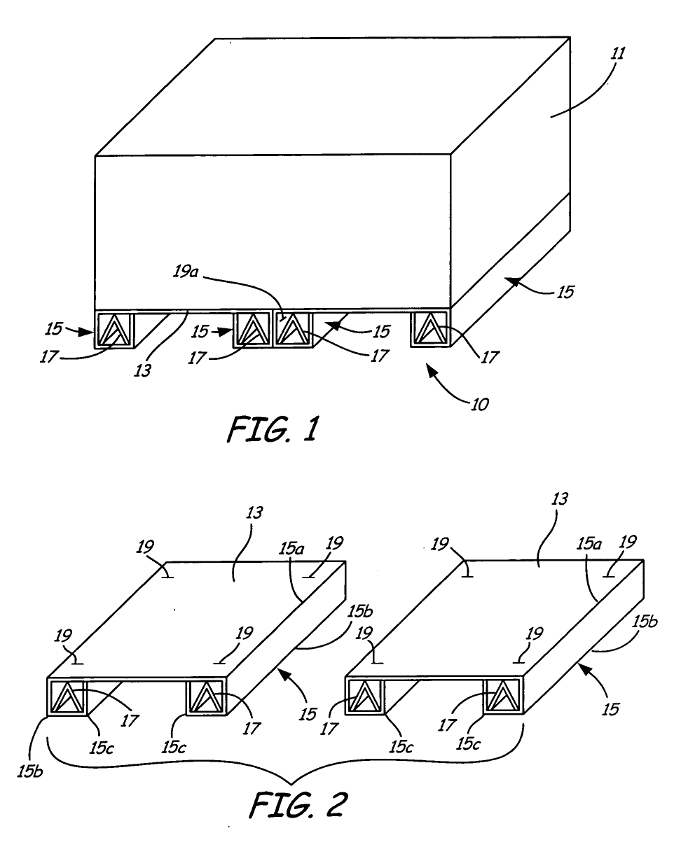

The figures illustrate the use of two pallets side by side, which is the preferred embodiment. This arrangement provides four box supports 15 and a shorter span on sheet 13 for each pallet. Boxes 15 are spaced such that a fork lift truck can engage the two pallets. When a load 11 is on the pallets, its weight adds stability to the pair of pallets. They may alternatively fastened together by conventional means, such as by straps, staples and the like. Staple 19a is shown in FIG. 1 as holding the boxes 15 together.

In production, the pre-folds on the cardboard components are made and the pre-formed pallets are shipped or delivered to the user. They can then be easily assembled by dock workers or other personnel at the site where the objects are to be loaded. Because the pallets are made from cardboard, they can be recycled, thus eliminating any expense in returning them, or they can be dis-assembled for shipping as flat cardboard if it is deemed necessary to reuse them. Thus considerable economic savings are achieved with the present invention, both in material and shipping costs as well as environmental savings using recyclable materials.

Although the present invention has been described with reference to preferred embodiments, workers skilled in the art will recognize that changes may be made in form and detail without departing from the spirit and scope of the invention.

1. A pallet device for holding and moving packages for shipping, comprising:
a first cardboard sheet having a front, a back and two sides, the two sides having pre-set folds such that the sides fold to form a box at each side positioned under the sheet;
a fastener to hold the shape of the box at each side;
a pair of second cardboard sheets each having a pre-set fold for forming each second sheet into a “L” shape, each second sheet being sized to fit inside one of the first sheet boxes such that such that the ends of the “L” shape engage inner corners of the box and the bend in the “L” contacts an inner surface of the box.

2. The device of claim 1, wherein the first sheet and pair of second sheets are formed from two ply cardboard.

3. The device of claim 1, wherein the fastener is a plurality of staples.

4. The device of claim 1, wherein the pre-set folds are formed by cutting a portion of the sheets.

5. The device of claim 1, wherein the pallet device comprises a pair of first cardboard sheets and second cardboard sheets formed as set forth in claim 1 and positioned side by side, whereby each of the pair supports about half the load on the pallet device.

6. The device of claim 5, wherein the pair of pallets are fastened together.

7. A pallet device for holding and moving packages for shipping, comprising:
first cardboard sheet means having a front, a back and two sides, the two sides having pre-set folds such that the sides fold to form a box at each side positioned under the sheet means;
fastener means for holding the shape of the box at each side;
a pair of second cardboard sheet means formed into a “L” shape, and being sized to fit inside one of the first sheet boxes such that such that the ends of the “L” shape engage inner corners of the box and the bend in the “L” contacts one inner surface of the box.

8. The device of claim 7, wherein the first sheet means and pair of second sheet means are formed from two ply cardboard.

9. The device of claim 7, wherein the fastener means is a plurality of staples.

10. The device of claim 7, wherein the pre-set folds are formed by cutting a portion of the sheet means.

11. The device of claim 7, wherein the pallet device comprises a pair of first cardboard sheet means and second cardboard sheet means formed as set forth in claim 1 and positioned side by side, whereby each of the pair supports about half the load on the pallet device.

12. The device of claim 11, wherein the pair of pallets are fastened together.

13. A method for making a pallet for holding and moving packages for shipping, comprising the steps of:
forming pre-set folds on the two sides of a first cardboard sheet having a front, a back and two sides, and folding the sides fold to form a box at each side positioned under the sheet;
fastening the boxes to maintain the shape of the box at each side; and
forming pre-set folds on a pair of second cardboard sheets and forming each second sheet into a “L” shape, each second sheet being sized to fit inside one of the first sheet boxes such that such that the ends of the “L” shape engage corners of the box and the bend in the “L” contacts an inner surface of the box.

14. The method of claim 13, wherein the first sheet and pair of second sheets are formed from two ply cardboard.

15. The method of claim 13, wherein the boxes are fastened using a plurality of staples.

16. The method of claim 13, wherein the pre-set folds are formed by cutting a portion of the sheets.

17. The method of claim 13, which further includes forming a pair of first cardboard sheets and second cardboard sheets formed as set forth in claim 13 and positioning them side by side, whereby each of the pair supports about half the load on the pallet device.

18. The method of claim 17, wherein the pair of pallets are fastened together.
